(19) United States
(12) Patent Application Publication
(10) Pub. No.: US 2025/0370728 A1
(43) Pub. Date: Dec. 4, 2025

(54) System and Method for Hierarchical and Adversarial Large Language Model-Based Automated Software Development

(71) Applicant: Cameron Immesoete, Orinda, CA (US)

(72) Inventor: Cameron Immesoete, Orinda, CA (US)

(21) Appl. No.: 18/732,387

(22) Filed: Jun. 3, 2024

(51) Int. Cl. G06F 8/35

(52) U.S. Cl. CPC G06F 8/35

(57) ABSTRACT

Implementations described herein relate to methods, systems, and computer programs that combine a Large Language Model (LLM) with an adversarial feedback loop for automated software development. The process involves prompting an LLM to generate code, iteratively refining it through self-prompts or external prompts, and employing adversarial agents to check for syntax errors, logical inconsistencies, and functional compliance with the original requirements. This method ensures the production of robust, error-free software. Some implementations may include a hierarchy of LLM instances where a subset focuses on coding while another subset supervises the process, akin to a managerial role.

### TECHNICAL FIELD

Embodiments relate generally to computer-based generative artificial intelligence and software development, and more particularly, to methods, systems, and computer-readable media for automating and improving software writing using adversarial LLM loops.

### BACKGROUND

Current software development practices involve significant human effort in coding, debugging, and ensuring that software meets its initial requirements. While LLMs have shown promise in generating code, their outputs often contain errors or do not fully align with the intended functionality. Therefore, there is a need for a system that not only generates code but also iteratively refines and validates it to ensure accuracy and functionality.

### SUMMARY

According to an aspect, a computer-implemented method of combining an LLM with an adversarial feedback loop for automated software development is provided. The method includes: prompting the LLM to write software; iteratively prompting the LLM or having it prompt itself to expand and refine the software; using an adversarial agent to check for syntax errors and logical inconsistencies; prompting the LLM to correct any identified issues; and employing a final adversarial agent to ensure the output software meets the original requirements.

In some implementations, the method further includes establishing a hierarchy of LLM instances, where a subset of instances generates code and another subset supervises the process, ensuring quality control and adherence to the initial specifications.

### BRIEF DESCRIPTION OF THE DRAWINGS

FIG. 1 is a system architecture that illustrates the main components of an example system and their interactions. This diagram includes components such as the user device, the LLM, the adversarial agents, the iterative prompting process, the syntax checking process, and the final validation process.

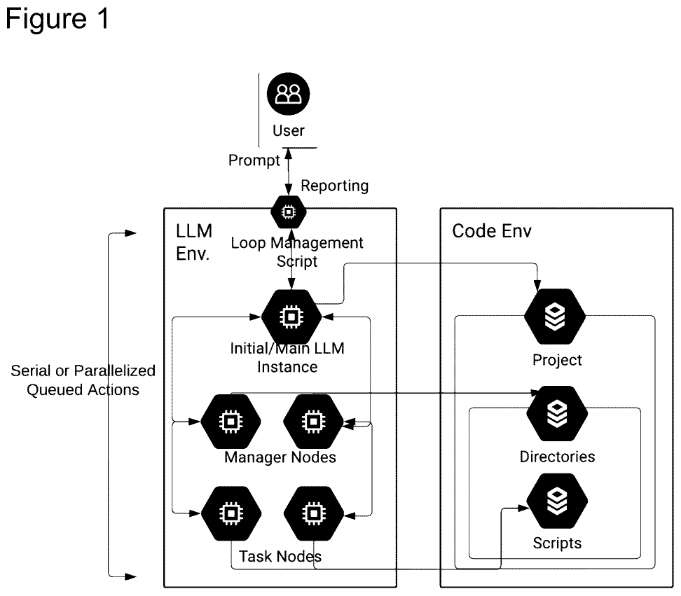

1. A computer-implemented method of combining a Large Language Model (LLM) with an adversarial feedback loop for automated software development, the method comprising:
a. prompting the LLM to write software;
b. iteratively prompting the LLM or having it prompt itself to expand and refine the software;
c. using an adversarial agent to check for syntax errors and logical inconsistencies;
d. prompting the LLM to correct any identified issues; and
e. employing a final adversarial agent to ensure the output software meets the original requirements.

2. The computer-implemented method of claim 1, wherein the adversarial agents simulate potential errors and edge cases to test the robustness of the generated software.

3. The computer-implemented method of claim 1, wherein the iterative prompting involves breaking down complex tasks into smaller, manageable sub-tasks for the LLM to handle incrementally.

4. The computer-implemented method of claim 1, wherein the final adversarial agent conducts a comprehensive review to ensure functional compliance with the initial software specifications.

5. The computer-implemented method of claim 1, further comprising:
a. establishing a hierarchy of LLM instances where a subset of instances generates code and another subset supervises the process; the supervisory subset of LLM instances is responsible for enforcing coding standards and best practices throughout the software development process.

6. The computer-implemented method of claim 1, wherein the adversarial feedback loop continues until the software achieves a predefined level of quality and functionality, performance, and reliability.

7. The computer-implemented method of claim 1, wherein the system includes mechanisms for logging and analyzing errors to continuously improve the LLM's coding capabilities, including but not limited to producing feedback and suggestions for improvement, potentially with adjustable scrutiny.
